(19) United States
(12) Patent Application Publication
(10) Pub. No.: US 2012/0044338 A1
(43) Pub. Date: Feb. 23, 2012

(54) VISUAL AIDING SYSTEM BASED ON ANALYSIS OF VISUAL ATTENTION AND VISUAL AIDING METHOD FOR USING ANALYSIS OF VISUAL ATTENTION

(75) Inventors: Hyung Jik LEE, Daejeon (KR); Chang Seok BAE, Daejeon (KR); Jeun Woo LEE, Daejeon (KR)

(73) Assignee: Electronics and Telecommunications Research Institute, Daejeon (KR)

(21) Appl. No.: 13/212,831

(22) Filed: Aug. 18, 2011

(30) Foreign Application Priority Data
Aug. 18, 2010 (KR) 10-2010-0079718

(51) Int. Cl. H04N 7/18

(52) U.S. Cl. 348/78; 348/E07.085

(57) ABSTRACT

Disclosed are a visual aiding system and a visual aiding method using analysis of user's visual attention. In the visual aiding system and method, by tracking user's pupil of eyes, user's focus information which is tracking information is matched (integrated) with an external image corresponding to a front region observed by a user. Thereafter, by using distribution of the eyes' focus information matched with an external image, a visual attention image block observed by the user is extracted from the external image. Thereafter, the extracted visual attention image block is enlarged with a predetermined multiple and provided to the user.

### CROSS-REFERENCE TO RELATED APPLICATIONS

This application claims priority under 35 U.S.C. §119 to Korean Patent Application No. 10-2010-0079718, filed on Aug. 18, 2010 in the Korean Intellectual Property Office, the disclosure of which is incorporated herein by reference in its entirety.

### TECHNICAL FIELD

The present invention relates to a visual aiding system based on analysis of visual attention and a visual aiding method using analysis of visual attention, and more particularly, to a visual aiding system based on analysis of visual attention designed to be wearable on a head for a user who cannot accurately view an object and a visual aiding method using the analysis of visual attention.

### BACKGROUND

In recent years, in the case of a blind person who completely loses a visual function, an image technology for replacing the visual function and a study for analyzing an image acquired by the image technology, converting an analysis result thereof into other types of information such as voice information or tactile information, and providing the information to the blind person who completely loses the visual function have actively progressed.

However, in the case of a blind person who does not completely lose the visual function, however, cannot accurately view the object in spite of using a visual aiding mechanism such as eye glasses, the voice information or tactile information does not particularly need to be provided to the blind person.

That is, providing the image information acquired by the image technology replacing the visual function to the blind person who does not completely lose the visual function sufficiently performs visual aiding.

Therefore, it is important to judge which image information is provided for effective visual aiding to the blind person who does not completely the visual function. That is, a study into the image information provided to the blind person who does not completely lose the visual function is important.

However, a research and development of analyzing which information among various pieces of information included in the image information and the method of effectively analyzing information to the blind person who does not completely lose the visual function is insufficient.

### SUMMARY

An exemplary embodiment of the present invention provides a visual aiding system including: a structure including a lens securing a sight and a support supporting the lens; a camera part installed on a front surface and a rear surface of the structure and generating a first image acquired by photographing a front region which a user observes and a second image acquired by photographing an eye region including a pupil of the user; a controller mounted on the side surface of the body and receiving the first and second images to generate a third image acquired by integrating the first image and the second image and partitioning the third image into a plurality of image blocks to generate distribution information indicating a distribution degree of focuses of the pupil for each image block; a visual attention analyzer receiving the distribution information from the controller to infer a visual attention lobe observed by the user in the front region and generating visual attention analysis information on a visual attention image block corresponding to the visual attention lobe among the plurality of image blocks; and a display part installed on a rear surface of the lens facing the pupil of the user, and receiving and displaying an enlarged visual attention image block after the controller receiving the visual attention analysis information from the visual attention analyzer extracts and enlarges the visual attention image block.

Another exemplary embodiment of the present invention provides a visual aiding method including: generating a first image acquired by photographing a front region which a user observes and a second image acquired by photographing an eye region including a pupil of the user; generating a third image where the focus of the pupil is displayed in the first image by integrating the first image and the second image; partitioning, by a controller, the generated third image into image blocks to generate distribution information representing a distribution degree of the focuses of the pupil for each block; inferring a visual attention lobe observed by the user in the front region based on the distribution information; and enlarging a visual attention image block corresponding to the visual attention lobe and displaying the enlarged visual attention image block through a display installed on the rear surface of the structure to face the eye region.

Other features and aspects will be apparent from the following detailed description, the drawings, and the claims.

### BRIEF DESCRIPTION OF THE DRAWINGS

FIGS. 1 and 2 are configuration diagrams stereoscopically showing a visual aiding system according to an exemplary embodiment of the present invention.

FIG. 3 is a block diagram schematically showing internal configurations of a controller and a visual attention analyzer included in the visual aiding system shown in FIGS. 1 and 2.

FIG. 4 is a flowchart for describing a visual aiding method using analysis of visual attention according to an exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

In the present invention, there are disclosed a visual aiding system and a visual aiding method by analysis of user's visual attention in order to solve problems in the related art. In the visual aiding system and method, by tracking user's pupils of eyes, eyes' focus information which is tracking information is matched (integrated) with an external image corresponding to a front region observed by a user. Thereafter, by using distribution of the eyes' focus information matched with an external image, a visual attention image block on which user's eyes concentrate is extracted from the external image. Thereafter, the extracted visual attention image block is enlarged with a predetermined multiple and the enlarged visual attention image block is provided to a user.

The visual aiding system of the present invention may be implemented as various outer shapes and is not particularly limited thereto, but in exemplary embodiments described below, a visual aiding system in which various module boxes and display devices are attached to a glasses-type structure which is wearable on a head is disclosed.

In the exemplary embodiments described below, the visual aiding system of the present invention is described as a system which is very useful to a visually impaired person who does not completely lose a visual ability, but it is apparent that the visual aiding system may be used as a system which is very useful to even a user having a normal visual ability. For example, the visual aiding system is applied to a telescope, a fluoroscope for military and non-military, and sunglasses to be used as a system which is very useful to even the user having the normal visual ability.

Hereinafter, exemplary embodiments of the present invention will be described in detail with reference to the accompanying drawings.

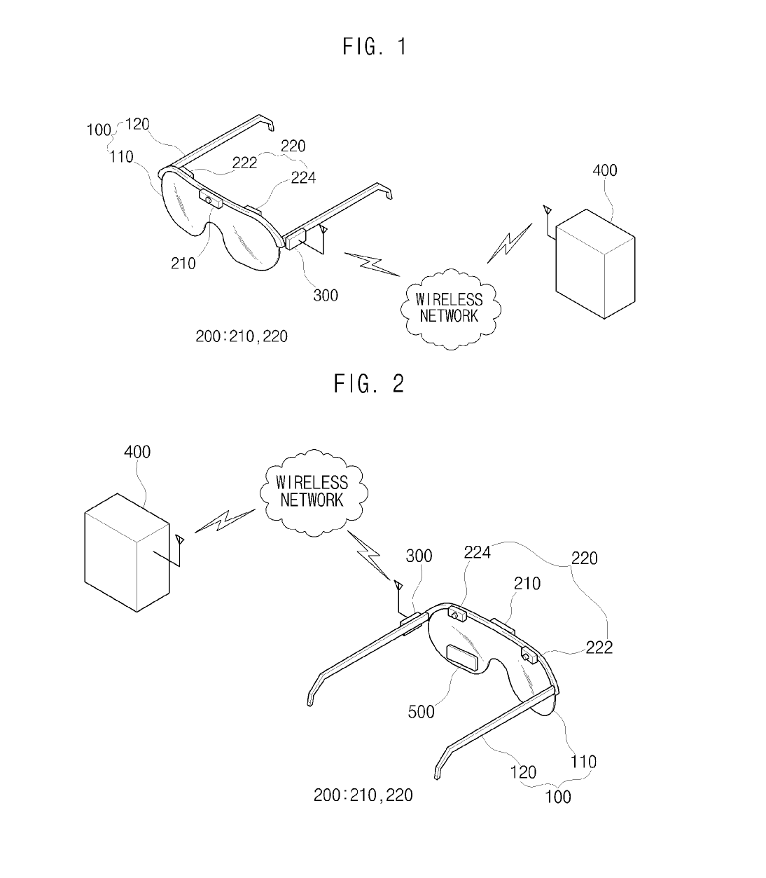

FIGS. 1 and 2 are configuration diagrams stereoscopically showing a visual aiding system according to an exemplary embodiment of the present invention.

Referring to FIG. 1, the visual aiding system according to the exemplary embodiment of the present invention includes a structure 100, a camera part 200, a controller 300, a visual attention analyzer 400, and a display part 500.

The structure 100 includes a lens 100 securing a view and a support 120 formed to be worn on a user's head by supporting the lens 110.

The camera part 200 includes a first camera 210 generating a first image acquired by photographing a front region which user's eyes face and a second camera 220 generating a second image acquired by photographing an eye region including a user's pupil. The first camera 210 is attached to a front surface of the structure 100, e.g., one end portion of the support 120 of the structure 100 to face the front region which the user's eyes face. The second camera 220 includes a right camera 222 photographing a right eye region of a user and a left camera 224 photographing a left eye region of the user. Accordingly, a second image includes a left image acquired by photographing a left eye region and a right image acquired by photographing a right eye region. Each of the right and left cameras 222 and 224 is attached to the other end portion of the support 120 to face the left and right eye regions of the user.

The controller 300 is implemented as a module box type to be attached to the side surface of the structure 100, e.g., a part of the support extending vertically from the lens 110. The controller 300 is electrically connected with the camera part 200. A conducting wire electrically connecting the controller 300 and a camera part 210 to each other is not shown for simplification of the figure. The controller 300 receives a first image from the first camera 210 of the camera part 200, receives a second image from the second camera 220, and generates a third image in which the received first and second images are integrated with each other. The controller 300 partitions the generated third image into a plurality of image blocks, calculates a distribution degree of focuses of user's eyes represented for each image block, and generates a calculation result as distribution information.

The visual attention analyzer 400 performs wireless communication with the controller 300 through a wireless network such as a WBAN or a WLAN and receives the distribution information from the controller 300 by using the wireless communication method. The visual attention analyzer 400 infers (detects or extracts) a visual attention lobe which the user's pupil concentratively faces in the front region based on the received distribution information and detects a visual attention image block corresponding to the visual attention lobe inferred from the plurality of image blocks. The visual attention analyzer 400 generates the detected visual attention image block as visual attention analysis information and transmits the generated visual attention analysis information to the controller 300 again.

The controller 300 extracts the visual attention image block from the first image based on the visual attention analysis information received from the visual attention analyzer 400 and enlarges the extracted visual attention image block at a predetermined ratio. The enlarged visual attention image block is provided to the display part 500.

The display part 500 is attached to a rear surface of the lens 110 facing the user's pupil and displays the enlarged visual attention image block provided from the controller 300 while the user wears the structure 100 on his/her head.

As such, the visual aiding system according to the exemplary embodiment of the present invention automatically recognizes a concerned region of an object observed by the user, that is, the visual attention lobe by tracking movement of the user's pupils, and extends and provides the recognized visual attention lobe to the user. Accordingly, the user may easily verify detailed information on the visual attention lobe (alternatively, the concerned region) corresponding to a predetermined portion of the object visually by only an action of observing the object without operating a predetermined apparatus.

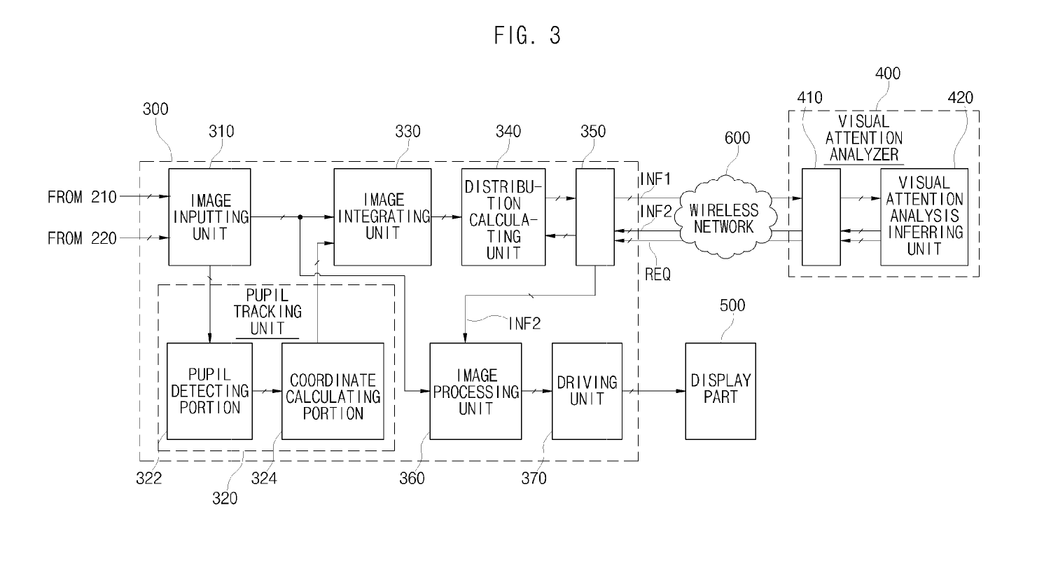

Hereinafter, referring to FIG. 3, the controller 300 and the visual attention analyzer 400 will be described in more detail.

FIG. 3 is a block diagram schematically showing internal configurations of a controller and a visual attention analyzer included in the visual aiding system shown in FIGS. 1 and 2.

Referring to FIG. 3, first, the controller 300 will be described in detail.

The controller 300 includes an image inputting unit 310, a pupil tracking unit 320, an image integrating unit 330, a distribution calculating unit 340, a first interface 350, an image processing unit 360, and a driving unit 370.

The image inputting unit 310 receives the first image from the first camera 210, receives the second image from the second camera 220, and transfers the first image to the image integrating unit 330 and the second image to the pupil tracking unit 320. During this process, the image inputting unit 310 may convert the received first and second images into image data processable in the controller 300.

The pupil tracking unit 320 receives the second image acquired by photographing an eye region including the user's eyes received through the image inputting unit 310 and detects the pupil region in the eye region from the second image. Thereafter, the pupil tracking unit 320 tracks the focus of the pupil in the detected pupil region.

Specifically, the pupil tracking unit 320 includes a pupil detecting portion 322 and a coordinate calculating portion 324. The pupil detecting portion 322 detects the pupil region in the eye region. For example, the pupil detecting portion 322 detects the pupil region in the eye region by using a difference between a brightness value outside the pupil and a brightness value inside the pupil in the eye region. The coordinate calculating portion 324 sets the center of the eye region as a reference coordinate and calculates a center coordinate of the detected pupil region on the basis of the set reference coordinate. The calculated center coordinate is a focus of the pupil. The calculated focus of the pupil, i.e., the center coordinate value of the pupil is transferred to the image integrating unit 330.

The image integrating unit 330 matches the second image to the first image received from the image input unit 310. That is, the image integrating unit 330 integrates the first image and the second image with each other and generates the third image as an integration result. Specifically, the image integrating unit 330 displays (matches) the focus of the pupil received from the coordinate calculating portion 324 to the first image to generate the third image in which the second image is matched to the first image. The generated third image is provided to the distribution calculating unit 340.

The distribution calculating unit 340 partitions the third image into N×N (N is a natural number of 2 or more) image blocks, calculates the number of the focuses of the pupil included (displayed) in each of the partitioned image blocks, and generates distribution information indicating a distribution degree of the focuses of the pupil for each image block. Herein, the distribution information includes index information defining the corresponding image block and information on the number of the focuses of the pupil distributed in the corresponding image block. The generated distribution information is provided to the first interface 350.

The first interface 350 converts the distribution information into a wireless signal according to a wireless communication standard such as the WBAN or WLAN and transmits the converted wireless signal into the visual attention analyzer through the wireless network 600.

Meanwhile, the rest of the components included in the controller 300, i.e., the image processing unit 360 and the driving unit 370 will be described after a description of the visual attention analyzer 400 described below.

Hereinafter, the visual attention analyzer 400 that analyzes the distribution information received from the controller 300 as the wireless signal type to infer (detect or extract) the visual attention lobe will be described.

The visual attention analyzer 400 includes a second wireless interface 410 and a visual attention analysis inferring unit 420.

The second wireless interface 410 extracts the distribution information from the wireless signal transmitted from the controller through the wireless network and provides the extracted distribution information to the visual attention analysis inferring unit 420.

The visual attention analysis inferring unit 420 analyzes the distribution information received through the second wireless interface 410 to detect a visual attention image block where the most focuses of the pupil are distributed and recognize the detected visual attention image block as the visual attention lobe. That is, the indexed image blocks are arranged according to the number of the focuses of the pupil and the image block where the most focuses of the pupil are distributed among the arranged image blocks is detected as the visual attention image block. The detected visual attention image block is recognized as the visual attention lobe. The visual attention analysis inferring unit 420 transmits visual attention analysis information INF2 regarding the recognized visual attention image block to the controller 300 through the wireless network 600.

Meanwhile, the image block where the most focuses of the pupil are distributed may be multiple while the visual attention analysis inferring unit 420 recognizes the visual attention image block. That is, a first image block where the most focuses of the pupil are distributed is detected and a second image block having the same number of focuses as the first image block may be detected. In particular, when the first image block is adjacent to the second image block, the image block in which the visual attention lobe attentively observed by the user's pupil is included cannot be accurately defined. Therefore, in this case, the visual attention analysis inferring unit 420 transmits request information REQ for requesting the distribution information again to the controller 300.

Therefore, the distribution calculating unit 340 partitions the third image received from the image integrating unit 330 in response to the request information into N−1×N−1 (N is a natural number of 2 or more) image blocks, and recalculates the number of the focuses of the pupil included (displayed) in each of the portioned image blocks again. That is, the distribution calculating unit 340 upsizes the partitioned image block and recalculates the number of focuses of the pupil included (displayed) in each of the upsized image blocks. Thereafter, the distribution calculating unit 340 retransmits the distribution information as the recalculated result to the visual attention analyzer 400 and the visual attention analyzer 400 recognizes the visual attention lobe based on the retransmitted distribution information. The recognized result is transmitted to the controller 300 through the wireless network as the visual attention analysis information INF2.

Referring back to the controller 300 of FIG. 3, the image processing unit 360 of the controller 300 receives the first image from the image inputting unit 310 and receives the visual attention analysis information INF2 through the first interface 350. Thereafter, the image processing unit 360 extracts the visual attention image block corresponding to the visual attention lobe from the first image according to the visual attention analysis information (INF2) and enlarges the extracted visual attention image block at a predetermined ratio, for example, may enlarge the extracted visual attention image block by reducing the resolution.

The driving unit 370 receives the enlarged visual attention image block from the image processing unit 360, and converts and outputs the received visual attention image block into data processable in the display part 500. For example, gray values of all pixels constituting the enlarged visual attention image block are converted into gray voltages corresponding thereto, respectively and the converted gray voltages are provided to the display part 500.

The display part 500 displays the enlarged visual attention image block in response to the converted gray voltage. As a result, the user can see an enlarged visual attention lobe which he/her observes. Herein, the display part may be implemented as a liquid crystal display module or an OLED module and is preferably implemented as the OLED without a backlight by considering the size, and the like.

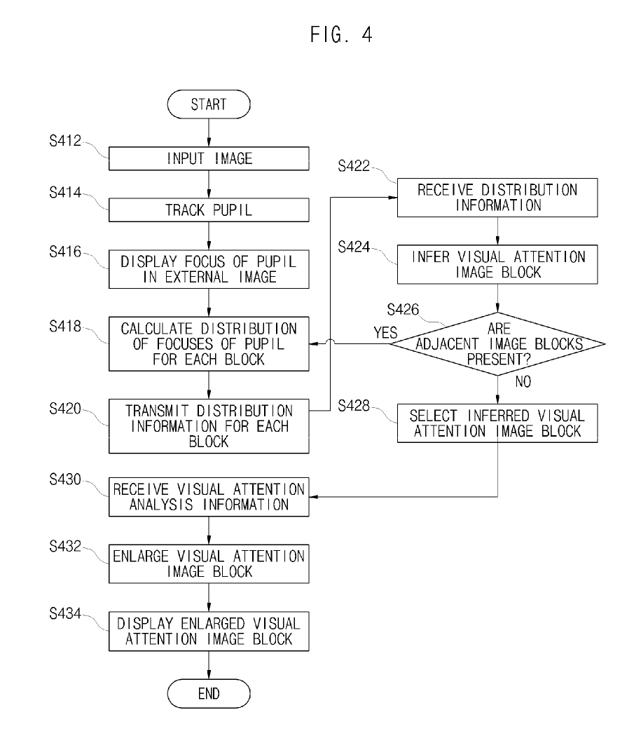

FIG. 4 is a flowchart for describing a visual aiding method using analysis of visual attention according to an exemplary embodiment of the present invention. For easy understanding of a description, FIG. 3 is also referred.

Referring to FIG. 4, first, the controller 300 of FIG. 3 receives a first image acquired by photographing a front region which user's eyes face and a second image acquired by photographing an eye region including a pupil of a person through a camera installed in a structure (S412).

Next, a pupil region is detected from the received second image, a center coordinate of the detected pupil is calculated, and the calculated center coordinate is defined as a focus of the pupil to thereby track the pupil (S414).

Thereafter, a third image in which the focus of the pupil is displayed in the first image is generated by integrating an external image, i.e., the first image and the second image with each other (S416).

Subsequently, the generated third image is partitioned into N×N (N is a natural number of 2 or more) image blocks and the number of focuses of the pupil displayed in each of the partitioned image blocks is calculated. Therefore, a distribution indicating a distribution degree of the focuses of the pupil is calculated for each image block (S418).

Next, the distribution result calculated for each image block is transmitted to the visual attention analyzer 400 of FIG. 3 as distribution information (S420).

Thereafter, the visual attention analyzer 400 receives the distribution information (S422) and analyzes the received distribution information to infer (recognize or detect) a visual attention image block (S424). In this case, when two or more adjacent visual attention image blocks are inferred (S426), calculation of the distribution indicating the distribution degree of the focuses of the pupil for each image block is requested to the controller 300 again (from S426 to S418). In this case, the controller 300 upsizes the partitioned image block to calculate the distribution of the number of the focuses of the pupil. That is, when first calculation of the distribution of the number of the focuses of the pupil is performed for each of N×N image blocks, the distribution calculation is performed for each of N−1×N−1image blocks when the distribution calculation of the number of the focuses of the pupil is requested again. Thereafter, the processes S420, S422, S424, and S426 are repeated.

Subsequently, finally, the visual attention analyzer 400 selects the visual attention image block and transmits information on the selected visual attention image block, i.e., index information indicating the visual attention image block to the controller 300 as visual attention analysis information (from S428 to S430).

Next, the controller 300 receives the visual attention analysis information (S430), extracts the visual attention image block from the external image received based on the received visual attention analysis information, i.e., the first image, and enlarges the extracted visual attention image block at a predetermined ratio.

Thereafter, the enlarged visual attention image block is displayed to a user through a display installed in the structure.

As set forth above, the present invention automatically analyzes a region which a user intends to see through analysis of user's visual attention and provides the analysis result to the user as an enlarged image. Accordingly, when a user having normal eye sight as well as users having very poor eyesight intend to know information on a predetermined object, information on the region which the user sees is automatically enlarged and displayed, thereby providing a visual aiding function to the user.

According to exemplary embodiments of the present invention, by providing as a format of enlarged image information a concerned region of an object observed by a user with a normal visual function as well as a user who does not completely lose a visual function, an effective visual aiding function is provided to the users. For example, in the case where the users cannot see a sign placed in a subway station or a menu placed at a general restaurant very well, when the users observe the sign or the menu, the effective visual aiding function is provided to the users by setting the sign and the menu as the concerned region and displaying the set concerned region to the users as extended image information. The present invention can be used in various application fields such as a face recognition field of verifying a person's identity or a GPS technology field.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A visual aiding system, comprising
a camera part generating a first image acquired by photographing a front region which user observes and a second image acquired by photographing an eye region including a pupil of a user;
a controller receiving the first and second images to generate a third image acquired by integrating the first image and the second image and partitioning the third image into a plurality of image blocks to generate distribution information indicating a distribution degree of focuses of the pupil for each image block;
a visual attention analyzer receiving the distribution information to infer a visual attention lobe observed by the user in the front region and generating visual attention analysis information on a visual attention image block corresponding to the visual attention lobe among the plurality of image blocks; and
a display part receiving and displaying an enlarged visual attention image block after the controller receiving the visual attention analysis information from the visual attention analyzer extracts and enlarges the visual attention image block corresponding to the visual attention lobe in the first image based on the visual attention analysis information.

2. The system of claim 1, further comprising:
a structure including a lens securing a view, and a supporting unit wearable on a head of the user by including a first support coupled with one end of the lens and a second support extending from the first support in a vertical direction to the lens,
wherein the camera part is installed in the first support and the controller is installed at the other end of the second support.

3. The system of claim 2, wherein the camera part includes:
a first camera installed at one end of the first support to face the front region and generating the first image; and
a second camera installed at the other end of the first support to face an eye region of the user and generating the second image.

4. The system of claim 1, wherein the controller includes:
a pupil tracking unit receiving the second image, detecting the pupil region in the eye region, and tracking a focus of the pupil in the pupil region;
an image integrating unit receiving the first image and information on the focus of the pupil from the pupil tracking unit to generate a third image in which the focus of the pupil is displayed in the first image;
a distribution calculating unit receiving the third image, partitioning the third image into N×N (N is a natural number of 2 or more), and calculating the number of focuses of the pupil included in each image block to generate the distribution information; and
a first wireless communication interface unit transmitting the distribution information to the visual attention analyzer according to a wireless network communication method.

5. The system of claim 4, wherein the pupil tracking unit includes:
a pupil detecting portion detecting the pupil region in the eye region based on a difference between a brightness value outside the pupil and a brightness value of the pupil included in the eye region; and
a coordinate calculating portion setting the center of the eye region as a reference coordinate and calculating a center coordinate of the detected pupil region as the focus of the pupil based on the set reference coordinate.

6. The system of claim 5, wherein the visual attention analyzer includes:
a second wireless communication interface unit receiving the distribution information according to the wireless network communication method; and
a visual attention analysis inferring unit receiving the distribution information through the second wireless communication interface unit, detecting the visual attention image block where the most focuses of the pupil are distributed among the image blocks based on the distribution information, inferring the detected visual attention image block as the visual attention lobe, and transmitting visual attention analysis information including information on the inferred visual attention image block to the controller through the second wireless communication interface.

7. The system of claim 6, wherein the visual attention analysis inferring unit requests retransmission of the distribution information to the controller when the detected visual attention image block is multiple and the multiple visual attention image blocks are adjacent to each other.

8. The system of claim 7, wherein the distribution calculating unit of the controller partitions the third image into N−1×N×1 image blocks in response to the request of the retransmission of the distribution information from the visual attention analysis inferring unit and calculates the number of the focuses of the pupil included in each of the partitioned image blocks to generate the distribution information.

9. The system of claim 1, wherein the controller further includes an image processing unit enlarging the visual attention image block by controlling the resolution of the visual attention image block extracted from the first image.

10. The system of claim 9, wherein the display part is installed on a rear surface of the lens facing the user's pupil, and receives the enlarged visual attention image block from the image processing unit, and displays the received visual attention image block to the user.

11. A visual aiding method, comprising:
generating a first image acquired by photographing a front region which a user observes and a second image acquired by photographing an eye region including a pupil of a user;
generating a third image where the focus of the pupil is displayed in the first image by integrating the first image and the second image;
partitioning, by a controller, the generated third image into image blocks having a first size to calculate a distribution degree of focuses of the pupil;
inferring an image block where the most focuses of the pupil are distributed among the multiple image blocks as a visual attention lobe observed by the user in the front region; and
enlarging a visual attention image block corresponding to the visual attention lobe and displaying the enlarged visual attention image block through a display.

12. The method of claim 11, wherein in the inferring as the visual attention lobe, when the image block where the most focuses of the pupil are distributed is multiple and the multiple image blocks are adjacent to each other, the distribution degree of the focuses of the pupil is recalculated by partitioning the third image into image blocks having a second size larger than the first size.
